(19) United States
(12) Patent Application Publication
(10) Pub. No.: US 2005/0250468 A1
(43) Pub. Date: Nov. 10, 2005

(54) OPEN WIRELESS ARCHITECTURE FOR FOURTH GENERATION MOBILE COMMUNICATIONS

(75) Inventors: WEI LU, CUPERTINO, CA (US); JIANHONG HU, CUPERTINO, CA (US)

Correspondence Address: WEI LU, 1218 BUBB RD, CUPERTINO, CA, 95014, US

(73) Assignee: WEI LU, CUPERTINO, CA (US)

(21) Appl. No.: 10/709,485

(22) Filed: May 9, 2004

(51) Int. Cl. H04M 11/00

(52) U.S. Cl. 455/403

(57) ABSTRACT

An open wireless architecture (OWA) for fourth generation (4G) mobile communications supporting various different wireless radio transmission technologies (or called air interfaces) and convergence of wireless networks and wireline networks by constructing an open architecture platform in the systems of base-band processing, radio frequency, controller, networking as well as service applications, etc. With this said OWA model, a fourth generation mobile communication system is defined and developed.

### BACKGROUND OF INVENTION

1. Field of the Invention

This invention relates to the architecture and system model to implement a converged broadband wireless communications supporting various wireless radio transmission technologies including cellular mobile standards, portable wireless access standards and any user-defined new wireless standards by constructing an Open Wireless Architecture (OWA) platform in the parts of base-band processing, radio frequency, controller, network interface as well as service applications, etc. Based on this OWA model, this invention defines a new product for the Fourth Generation (4G) mobile communications including base station and terminal design.

2. Description of the Prior Art

The number of subscribers for mobile communications has increased much faster than predicted, particularly for terrestrial use, and the majority of traffic is changing from speech-oriented communications to multimedia communications. It is generally expected that the number of portable handsets will exceed the number of PCs connected to the Internet. The step towards Fourth Generation mobile (4G) or beyond 3G (B3G) has been taking to support advanced and wideband multimedia services. The interworking between 4G and other access systems in terms of horizontal and vertical handover and seamless services with service negotiation including mobility, security and quality-of-service (QoS) will be a key requirement. Therefore, the most important issue in developing future 4G mobile systems is the architecture based on the converged broadband wireless platform and targeted for Open Wireless Architecture (OWA).

Wireless applications in strong support of vehicular and pedestrian users has emerged as a cornerstone of new generation communications. When coupled to the emerging broadband wireline infrastructure, wireless access and wireless mobile will extend the benefits of multimedia services from the home and business environments, ushering in an era of anyone, anywhere, anytime, any media communications.

In future 4G mobile communications, two economically contradictive demands will arise; ubiquity and diversity. Open, global and ubiquitous communications make people free from spatial and temporal constraints. Versatile communication systems will also be required to realize customized services based on diverse individual needs.

The flexibility of wireless mobile IT (wmIT) can satisfy these demands simultaneously. Therefore, wmIT can be seen to play a key fundamental role in the 21ST century.

The user expectations are increasing with regard to a large variety of services and applications with different degree of quality of service, which is related to delay, data rate and bit error requirements. Therefore, seamless services and applications via different wireless access systems and technologies that maximize the use of available spectrum will be the driving forces for future wireless developments.

The B3G/4G vision from the user perspective can be implemented by integration of these different evolving and emerging wireless technologies in a common flexible and programmableplatform to provide a multiplicity of possibilities for current and future services and applications to users in a single terminal. Systems of 4G mobile will mainly be characterized by a horizontal communication model, where different communication technologies as cellular, cordless, WLAN type systems, short range wireless connectivity and wired systems will be combined on a common platform to complement each other in an optimum way for different service requirements and radio environments which in our words called “Open Wireless Architecture (OWA)”.

OWA will eventually become the global industry standard to integrate various wireless air-interfaces into one wireless open terminal where the same end equipment can flexibly work in the wireless access domain as well as in the mobile cellular networks. As mobile terminal (rather than wireline phone) will become the most important communicator in future, this single equipment with single number and multiple air-interfaces (powered by OWA) will definitely dominate the wireless communication industries.

The OWA platform can not only improve the spectrum efficiency, increase wireless data-rate and optimize network resource, but also provide cost-effective solution to enhance the wireless communication services which is very essential for the next generation business model of mobile communications.

### SUMMARY OF INVENTION

This invention is directed to a new wireless and mobile communications system based on the invented Open Wireless Architecture (OWA) to support the convergence of various wireless standards, including existing and future mobile cellular standards, portable wireless access standards and local area wireless network standards, etc., as well as convergence of broadband wireless networks and wireline networks. The wireless communications, in the last twenty years, have evolved from a simple transmission technology to a more complicated system technology. With the rapid development in different industrial applications, lots of wireless standards have been defined on the world-wide basis, and it is becoming very hard to have all the countries and industries to agree on the single wireless standard internationally because of different interests behind the scene. Therefore, the initial objective of the ITU (international telecommunications union) IMT-2000 single standard for third-generation (3G) had been failed, which resulted in multiple standards across the global.

3G has been stuck worldwide for over six years because 3G did not fundamentally improve the wireless architecture compared with the second-generation (2G), like GSM or TDMA, etc. This is very important because the wireless communications is much different from wireline communications, and it develops very rapidly. The major problems remaining in the 3G solution include (but not limited to): 1. Single architecture oriented. 2. Spectrum management and regulation. 3. Inter-operability between networks. 4. Compatibility between functional segments. 5. Infrastructure optimization.

Currently, there is at least one wireless standard coming out every month on the worldwide basis which may include international or regional standard. Each standard consumes certain amount of spectrum and generates additional inter-operability issue, etc. On the user application side, people feel puzzling to select the right services and the right networks. It also keeps the cost very high which is the main obstacle for a successful business model.

To solve these problems, the only way is to define the Open Wireless Architecture (OWA) which the computer industry used the same way back to 80s. This OWA of the present invention is becoming the global trend for the upcoming fourth-generation (4G) mobile communications.

The new architecture and system of this invention incorporate both the open base-station architecture and the open terminal architecture which consist of the open models in the base-band processing, radio frequency (RF), smart antennas, digital converters, controllers, air-interface modules as well as network interfaces, etc.

The invention of this OWA system includes the following parts:

First, the invention defines a new open architecture for the design of next generation wireless and mobile communications. The present invention supports any air-interfaces (or called radio transmission technologies) by constructing the open processing engines to handle any time-division multiple access (TDMA), code-division multiple access (CDMA) or frequency-division multiple access (FDMA) and any user-defined solutions. Attached with the open processing engines of this invention, the digital converter and channellizer are reconfigurable, and the RF radio and smart antenna module are programmable.

Second, the open system of the present invention can detect either automatically or manually, the available air-interfaces within the user”s service area, by processing and analyzing the channel, frequency, coding, modulation and/or duplex mechanism as well as processing on user-defined mechanism. After the air-interfaces are detected, the OWA of the present invention will check the necessary system modules (software components, database and parameters, etc) installed well. In case the installation is needed, the OWA of the invention will guide the system to either inserting a memory card (or called SIM card) of the required module, or connect through a broadband network interface to download the required module from the Internet or other networks. After the installation is completed, the underlying communication path of the selected air-interfaces is fully set-up, and the administrative access to the selected wireless networks is enabled. Then, the OWA of the invention will further process the service criteria (authentication, security, registration, etc) before the user is approved to use the service. The system of the present invention can also provide an automatic reconfiguration method to help lock the best available service defined by the user itself.

Third, the OWA of the present invention defines a common Air-Interface BIOS (basic input/output system) across the entire physical layer and the immediate link layer and MAC (media access control) layer, etc, so that the main functional units (including hardware and system software, etc) can be easily defined by the Open Interfaces. This Air-Interface BIOS of the present invention develops the new definable and programmable wireless modules to enable the standalone wireless subsystems with open interface standards, which become the optimal solution to resolve the interoperability and compatibility problems in the wireless communications. The BIOS model of the present invention also greatly support the convergence with the broadband wireline networks and the computer and data communications where similar open architecture apply.

Fourth, the OWA of the present invention provides an optimal open architecture in RF and Smart Antenna units to facilitate the shared spectrum management and dynamic spectrum allocation to increase the spectrum utilization. The system of the present invention searches for the available spectrum bands by comparing with the dynamic spectrum look-up table of the region and the RF configuration of the said system, etc. Then, the system of this invention vention adapts the RF and Antenna controlling units to reconfigure the transceiver to run in the candidate spectrum bands, with some adjustment or calibration, until the required spectrum is selected and locked. The OWA of the present invention also supports the user-defined dynamic spectrum management schemes, for example, second-ownership of allocated spectrum or spectrum vacation, etc.

Fifth, the OWA of the present invention provides a generic open platform of resource management, configuration management and convergence layers to enable the next generation base-station and terminal to be applied in various emerging applications. With these new architecture designs, the system of the present invention is targeted to reach the best system performance in terms of access control, spectrum efficiency, bandwidth allocation, datarate, capacity and infrastructure cost, etc. The OWA of this invention supports both physical layer transmission convergence on adaptive modulation, coding, equalization, etc, and service convergence of ATM, IP, E1, T1, DSL as well as user-defined transport solution, etc. The open service model of this invention includes Voice-over-IP (VoIP) standard as well. In addition, with this OWA system of the present invention, the open base-station can be reconfigured to function as wireless router, soft-switcher, access gateway or super DSP (digital signal processing) engine, etc. The open terminal of the present invention can be reconfigured for intelligent communicating, mobile computing, mobile office, conformance testing, ad-hoc connecting as well as emergency station for both personal emergency and city-wide emergency.

Sixth, the OWA system and method of the present invention defines a new cost-effective business model for service providers and operators which can save lots of investment in spectrum licenses, standards marketing, services marketing and infrastructure replacement, etc. The users with the OWA terminal of the present invention normally do not care much of the underlying wireless standards while the available services by various air-interfaces are layered and configured (either manually or automatically) by users” preference and defined by the users themselves. This OWA business model of the invention is somehow similar to the wireline business model where users are not aware in general what the underlying telecommunication networks are, they only care on best and cost effective services. The providers and operators of this OWA model of this invention share their revenues and profits based on overall services sale in the region, position in the value chain, access infrastructure and other to-be-defined criteria of the business.

Lastly, based on this OWA system of the present invention, a prototype 4G wireless mobile terminal has been defined, where different wireless standards are supported in this single open terminal with single phone number.

This intelligent terminal of the present invention is able to detect various air-interfaces based on different technologies including channel processing, frequency carrier, coding scheme, modulation method and user-defined mechanism as well. The OWA terminal of this invention also provides many advanced features for the 4G applications around the year from 2010 to 2020 which include intelligent information input, enhanced security scanning, radiation warning and health diagnostics, automatic power control as well as VoIP enabler, etc.

All these and other introductions of the present invention will become more clear when the drawings as well as the detailed descriptions are taken into consideration.

### BRIEF DESCRIPTION OF DRAWINGS

For the full understanding of the nature of the present invention, reference should be made to the following detailed descriptions with the accompanying drawings in which:

FIG. 1 is an Open Base-Station & Terminal Processing Engine, where main OWA processing blocks of this invention are listed.

FIG. 2 is the Open Terminal Model, where main hardware and software functional units of the invention are listed.

FIG. 3 is an Open Base-Station Software Architecture, where the software modules and flowcharts of the present invention are listed.

FIG. 4 is a prototype 4G mobile terminal based on the OWA system of the present invention.

### DETAILED DESCRIPTION

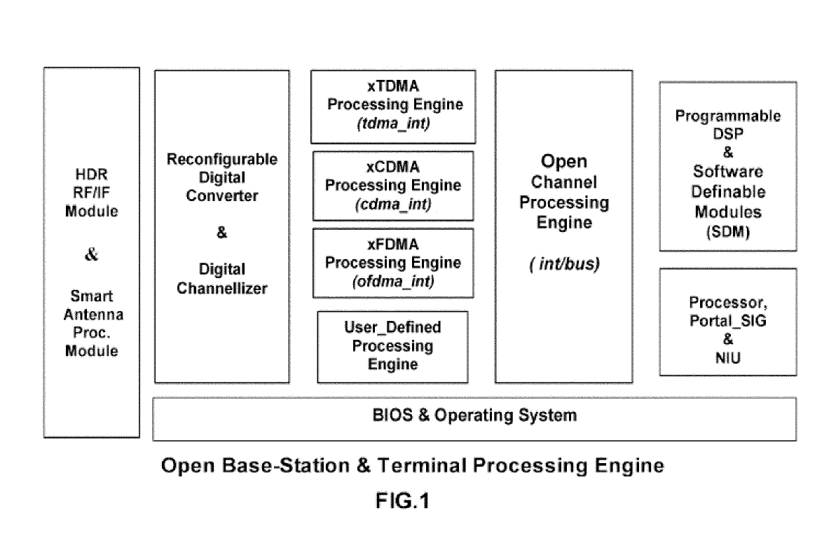

FIG. 1 is the Open Base-Station and Terminal Processing Engine of the present invention. The key units are:Hardware Defined Radio (HDR) RF/IF Module and Smart Antenna Processing Module these two open modules of this invention define the portable radio for the related wireless standards or air-interfaces. The HDR module of the invention can include either RF/IF mixed radio, or just RF single radio where IF is not necessary with certain new technologies (i.e. superconductivity, etc). The radio port is of open standard so that different vendors can provide this function part. The smart antenna module of this invention provides the enhanced performance and capacity, etc by using many advanced antenna technologies, for example, antenna digital beam-forming (DBF), MIMO (multiple-in, multiple-out), space-time coding, diversity, calibration etc. This smart antenna module of the invention also helps much in the shared spectrum management and dynamic frequency allocation.

Reconfigurable Digital Converter and Digital Channellizer It includes the reconfigurable broadband digital up-converter and digital down-converter to/from the frontend RF radio or RF/IF radio, and the initial digital channelization from/to the original radio frequency channels by different technologies.

The Air-interfaces Processing Engines of the invention support the physical layer, link layer and MAC (media access control) layer processing of the common radio transmission technologies (or called air-interfaces) of TDMA (time division multiple access, CDMA (code division multiple access) and FDMA (frequency division multiple access), as well as the user-defined new air-interfaces. These open processing engines are the core functional units to support multiple wireless standards in such a single system of the present invention.

The next Open Channel Processing Engine of the invention is to decode and/or demodulate the user information and the control information, etc out of the base-band channels (either by TDMA, CDMA, FDMA or user-defined), and vice verse.

Programmable DSP (digital signal processing) and Software Definable Modules (SDM) It defines the portable, transferable and switchable software modules containing air-interface frameworks, structures, algorithms and/or parameters, etc in a plug-play memory card (or called SIM card) or downloadable from the broadband internet connections. It also defines the modules” switching between different air-interfaces by software and DSP, etc.

Processor, Portable SIG (signaling) and NIU (network interface unit) This defines the system controlling, signaling and broadband network (e.g. Internet) interface functions of the present invention.

BIOS and Operating Systems (OS) the open Air-interface BIOS architecture of this invention is a revolutional approach for the design of the next generation wireless and mobile communications. The BIOS of the invention defines the basic interface structure for the multiple wireless standards (either common standards or user-defined), standards switching, functional modules as well as switching between internal and/or external base-band modules, etc. The OS module supports Windows, Linux or new user-defined solutions which are switchable and reconfigurable.

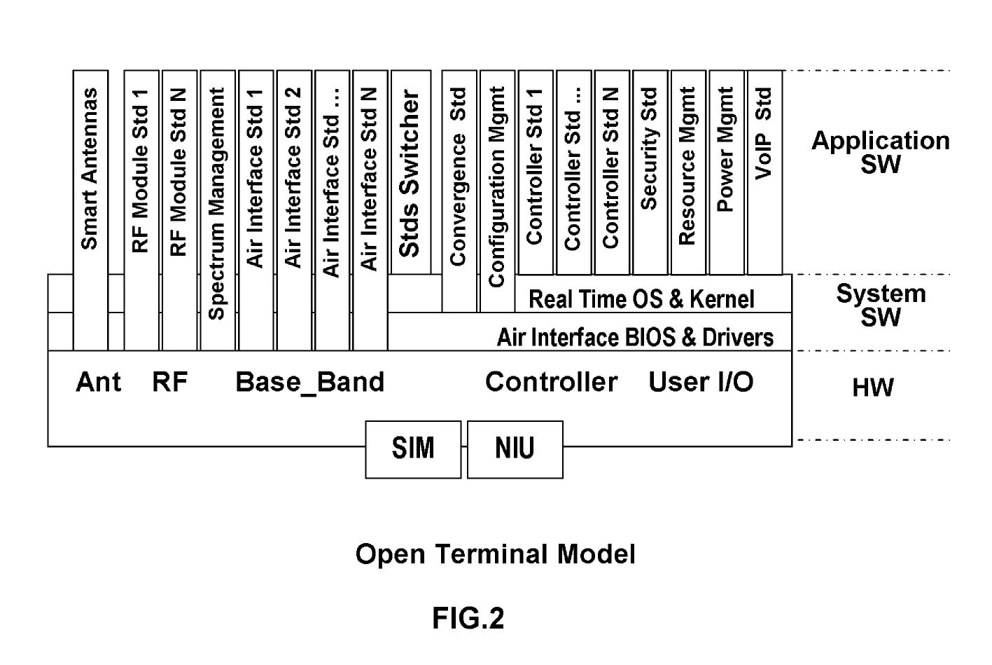

FIG. 2 is the Open Terminal Model of the present invention. The model of the invention is constructed on the common hardware platform consisting of Smart Antennas, Radio Frequency (RF) units, Base-Band units, System Controllers and other User-defined I/O (Input/Output) as well as Network Interface Unit (NIU) and Memory Cards (SIM cards, etc), etc. Based on this open and generic platform, some applications software modules are directly attached to this physical layer platform for best system performance and immediate control of the underlying system components, etc. These direct modules include Smart Antennas module, RF modules for various standards, Spectrum Management module, Air Interface modules for various wireless standards as well as physical layer transmission convergence modules for adaptive modulation, coding and equalization, etc.

Some standalone application software modules, which are portable, switchable and transferable, are normally locating on the layer of open Air Interface BIOS and Drivers, through a standard Real Time OS (or user-defined OS) and the kernel which helps the user-friendly programming and further development of the applications. These OS and BIOS layers are system software and therefore very important for the whole system performance. In addition, the open interface of the BIOS layer maps the different parameters, structures and signaling, etc of various air-interfaces and various functional modules into the common and open processing engines, open controllers and other open subsystems. The above mentioned application modules of the present invention include Standards Switcher between various air-interfaces; Convergence Standard modules for both service convergence, transmission convergence and convergence between wireline networks and wireless networks etc; Configuration Management modules for different applications, services and underlying system operations, etc; Controller Standards modules for various wireless standards on signaling and controlling, etc; Security Standard module for the enhanced security management of the terminal, for example, fingerprint scanning, pattern scanning, user detection, MAC layer encryption, etc; Resource Management modules for the most efficient usage of the system resources including channels, capacities, bandwidth, processing power, spectrum, access controls, flow controls, traffic controls as well as other important performance parameters; Power Management module for monitoring, calculating and optimizing the system power consumption including RF, base-band processing, controllers and applications” execution, etc; Voice-Over-IP Standard module for support of voice services in the All-IP end-to-end wireless connections of the future 4G mobile networks.

Some software modules including Air Interface modules and Controller modules, etc may be downloadable from the broadband network connection through the NIU, or portable by inserting the Memory Card (or SIM card) into the terminal memory slot.

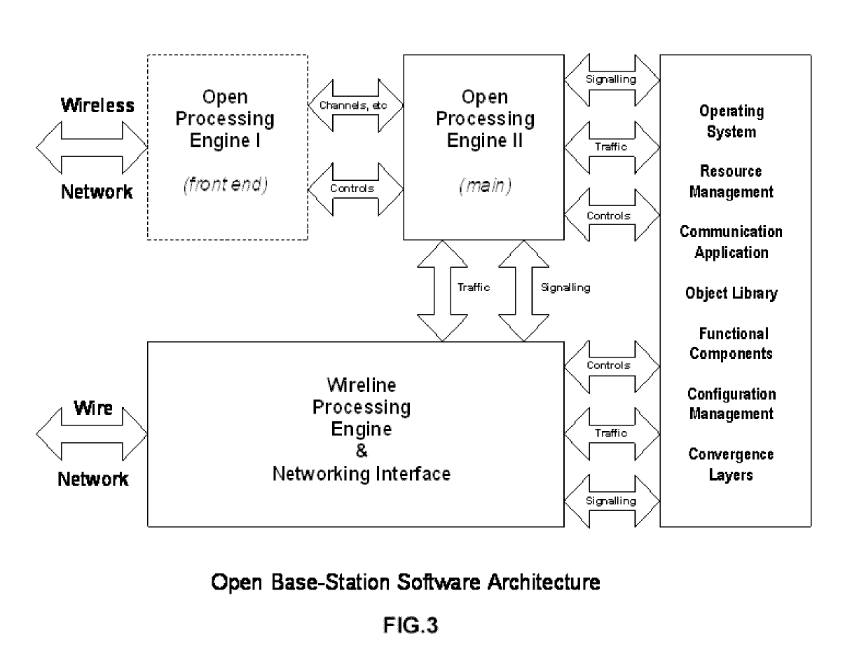

FIG. 3 describes the Open Base-Station Software Architecture of the present invention. It in general, defines the convergence of the open wireless systems of this invention with the wireline networks by listing the key software interfaces and the common software modules. The open base-station of the present invention can be reconfigured to operate as wireless router, soft-switcher, wireless tester, access gateway and super signaling processing engine, etc based on this open architecture of the invention. The common software modules include Operating Systems which are switchable and portable; Resource Management for wireless part and wireline part to optimize the system performance; Communication Applications for future-proven services and applications; Object Library for open software modules and common platforms, etc; Functional Components for key software definitions, segments and processes, etc; Configuration Management for system setting, updating and retrieving as well as service definition and user preference, etc; Convergence Layers for service convergence, transport convergence and transmission convergence, etc to maximize the convergence between wireless and wireline networks including services, applications, engineering and infrastructure, etc.

The Open Processing Engines of the present invention include two parts: one is in the front end for initial channel processing of various air-interfaces, etc. The other part is in the main open processing units to decode and/or demodulate the incoming channels into separate information streams of signaling, traffics or controls, and vice verse. The Wireline Processing Engine and Networking Interface perform the wireline signal processing and information transmission, etc, and meanwhile, provide the broadband common access point (CAP) to the backbone wireline networks so that the base station can access various wireline standards including ATM, E1/T1, DSL, Optic and userdefined interfaces, etc.

This centralized distributed open software architecture combines the transmission, networking and switching into one body to construct an open broadband platform to optimize the performance of PDM (packet division multiplex) networks as well as PDM/TDM (time division multiplex) mixed networks. This open base-station architecture of the present invention also supports very well the wireless routing functions and the wireless ad-hoc functions so that the wireless networks can operate independently from the backbone wireline networks any time controlled by the said open base-station. This is very important and userful for special applications like military applications, emergency applications or industrial applications, etc.

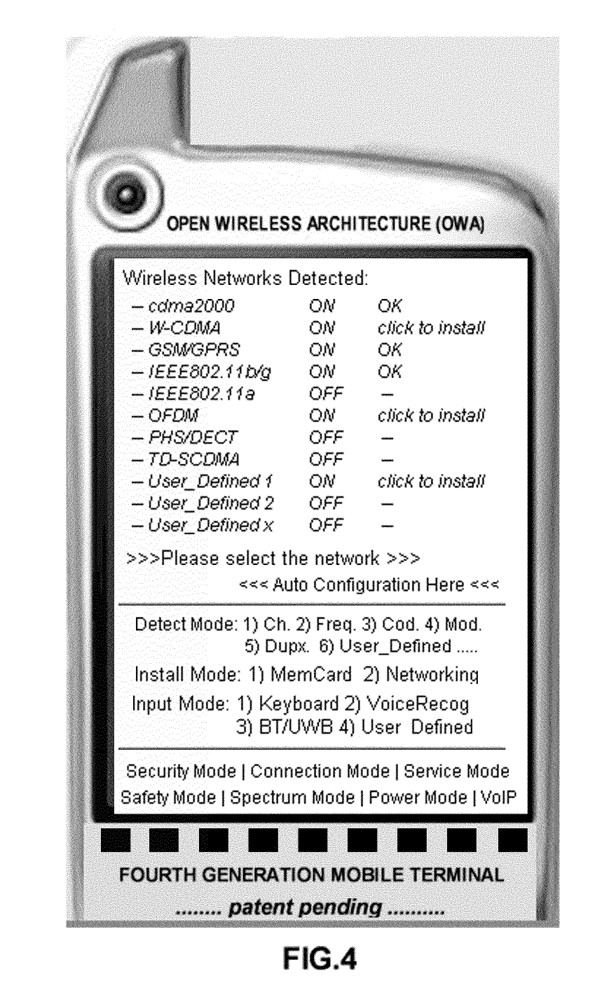

FIG. 4 defines a prototype Fourth Generation (4G) Mobile Terminal based on the Open Wireless Architecture (OWA) of the present invention. In addition to the hardware features of this next generation mobile phone including camera, sensors, smart antennas, security button, radiation detector, GPS receiver, etc, the software features of this invention determine the technology advancement of the 4G mobile communications, powered by the OWA of the present invention. These features include:

Wireless Networks Detected:—the first column lists the candidate standards to be scanned in the service region; the second column lists the detected wireless networks (or standards) in the service area; the third column checks whether additional software module is required for the detected standards. User has the full freedom to select any detected network for communications, or set-up the preferred standard and mode through the “Automatic Configuration” icon on the screen.

Detect Mode:—User can select different detecting technologies (by channel, frequency, coding, modulation, duplex, etc) to detect the wireless standards in the service area or can define the own method to detect the air interface. If the user does not select it manually or set up as auto-mode in the configuration page, the system of the invention will intelligently detect the best wireless network with criteria defined by the user.

Install Mode:—if one wireless network is detected and addition software module is required, the system of the invention will prompt in the screen to request the user to install the required module. There are two options to install the software, one is by memory card or SIM card containing the required module; the other is to download the required software module from the Internet through available broadband networks either by wireline networking interface (for example, DSL/USB port, etc) or wireless networking interface (for example, IEEE 802.11, etc).

Input Mode:—the system of the present invention provides multiple choices for information input for this 4G mobile terminal. User feels free to select the Screen Keyboard for message input (i.e. e-mail, short message, etc), or select Voice Recognition feature to automatically convert your voice into the information data for the system. The terminal of the invention can also capture the information input by short-distance wireless transmission technologies, for example, Blue Tooth (BT) standard or Ul-tra Wide Band (UWB) standard, etc. from portable digital camera, laptop, sensor, detector, etc. In addition, the user can define its own input technology and reconfigure into this intelligent terminal of the present invention.

Security Mode:—the terminal of the present invention provides the enhanced security features for communications which include information security, service security and transmission security, etc. Users can define their security levels in this security page. The terminal of the invention can also support finger-print scanning and detecting, and other user-defined identification technologies for 4G mobile applications. The pattern of the finger print or other user-defined (for example, eye pattern, etc) can be stored in the internal memory chip, external memory card or remote security server through networking.

Connection Mode:—the terminal of the present invention supports open connection and networking topology which include traditional mobile networking (terminal to base-station to switch, etc), ad-hoc (terminal to terminal directly, etc), broadcasting (point to multi-points, etc), paging or other user-defined communication topology. This is very useful in some special applications like military applications, emergency applications and some industrial applications, etc.

Service Mode:—user can define own service requirements based on quality of service, bandwidth, traffic model, usage preference, etc of voice, data and multimedia application. These parameters are important for the calculation of the optimal billing model and selection of the right wireless networks on the services. The terminal of the invention supports full Service-on-Demand and other user-defined service model for 4G mobile applications.

Safety Mode:—the terminal of the present invention provides a future-proven solution to secure the safety issues of the mobile users which include Health Watch (wireless radiation detection, monitoring and warning of the terminal; scanning of blood pressure or pulse rate; alcohol scanning, temperature scanning, etc), Emergency Detection (smoke detection, fire detection, gas detection, chemical detection, etc) and Emergency Response (automatically transmit the emergency data to the emergency center and activate the Terminal Emergency mode subject to either personal emergency or city-wide emergency where the whole wireless network resource will be reconfigured to deal with emergency communications only as the highest priority), etc. In this safety mode of the invention, several safety sensors and GPS (global position system) location receiver, etc are embedded in the terminal hardware, and these data will be sent to the network center in case of emergency or health threat.

Spectrum Mode:—the open terminal architecture of the present invention supports most efficient spectrum management schemes including shared spectrum, dynamic spectrum allocation and multiple spectrum ownership, etc to utmost utilize the available spectrum. The system of the invention can also define new spectrum management method to manage the licensed or unlicensed spectrum available in the service region for the future 4G mobile communications.

Power Mode:—the system of the present invention defines an optimal power management solution to minimize the system power consumption including base-band processing, RF, controllers as well as applications, etc. User can also configure the power setting (based on user traffic model, usage preference, service demand, etc) to mostly save the system power.

VoIP:—the system of the present invention provides full protocol stacks to support Voice over IP standard which becomes important in the future wireless communications. The OWA system of the invention establishes a full All-IP connection between the terminal to terminal, terminal to base-station, base-station to base-station and beyond.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

1. An open wireless architecture (OWA) for fourth generation mobile communications said system comprising:
a) A wireless communication terminal device supporting various different wireless standards (air interfaces) in the same device with same unique identifier and capable of communicating with other devices, systems or networks through a wireless medium or over-the-air network,
b) An advanced computer system equipped with full networking facilities to access various different backbone networks through wireline networking interfaces or sometimes through broadband wireless access systems,
c) An advanced transceiver system supporting various different air interfaces to interconnect said wireless communication terminal device, etc through the air link,
d) said transceiver system connected to said computer system to construct the base-station as a whole,
e) said wireless terminal device can also connected to different wireline networks through its networking interfaces in the said wireless terminal device,
f) said base-station can connected to other base-station either over the wireline networks or over broadband wireless access system through said computer system, or by over-the-air networks through said transceiver system,
g) said wireless terminal device can also connected to other wireless terminal device through the air link in an ad-hoc mode in case of special situations.

2. The Open Wireless Architecture (OWA) for fourth generation mobile communications of claim 1 wherein: both said wireless terminal device and said base-station further comprising:
a) An open processing engine to process the signals and protocols of various different air-interfaces (including user-defined air interface) for over-the-air networking and transmission,
b) A reconfigurable digital converter to transform the received signals to the digital base-band signals and vice verse, and connected to said open processing engine,
c) A programmable radio frequency (RF) module and smart antenna processing module of different frequencies to support different air-interfaces, and connected to said digital converter,
d) A software definable module (SDM) containing parameters, algorithms and protocols, etc of some wireless air-interfaces to be stored in an external memory card or downloaded from networks,
e) An open wireless BIOS (basic input/output system) structure capable of providing the common and open interfaces to said processing engine, said digital converter, said RF module and said SDM, etc.

3. The Open Wireless Architecture (OWA) for fourth generation mobile communications of claim 1 wherein: both said wireless terminal device and said base-station further comprising:
a) A system software module to support dynamic spectrum management, spectrum sharing and resource management to increase spectrum efficiency and optimize the system performance,
b) A convergence layer module to converge wireline and wireless networks and services, as well as transmission convergence, etc,
c) A configuration management module to enable flexible system re-configuration when wireless air-interfaces change, wireline networking changes or system settings change, etc.

4. A system as recited in claim 1 wherein said wireless terminal device capable of system software running upon the system hardware directly while the application soft-ware executing on the real-time OS (operating system) standards through said open wireless BIOS.

5. A system as recited in claim 2 wherein said open processing engine decodes, de-channelizes and demodulates the base-band channel signals and control signals of said various air-interfaces into detailed digital signaling, traffic and control information, and vice verse.

6. A system as recited in claim 1 wherein said base station can be reconfigured and re-programmed as wireless router, mobile soft switch or wireless gateway, etc.

7. A system as recited in claim 1 wherein said base station can be reconfigured to be portable and/or mobile as well for military applications or special industrial applications. In that case, the said computer system connects to the backbone networks through said broadband wireless access systems instead of said wireline networking interfaces.

8. A system as recited in claim 1 wherein said wireless terminal device and said base-station can communicate each other over said various different air interfaces including time-division multiple access (TDMA), code-division multiple access (CDMA), frequency-division multiple access (FDMA) or other user-defined interfaces.

9. A method as recited in claim 8 detecting said various different air-interfaces for said wireless terminal device and said base-station, said method comprising:
a) performing initial channel processing from the received signals, or
b) scanning frequency carrier from the received signals, or
c) performing different decoding scheme from the received signals, or
d) performing different demodulation scheme from the received signals, or
e) running user-defined detecting technologies.

10. A method as recited in claim 1 connecting said transceiver system and said computer system through open software structures, comprising:
a) open operating systems supporting Windows, Linux or user-defined,
b) open resource management covering spectrum, bandwidth, channels, capacity, processors, power, storage and services, etc,
c) open communication application software enabling user-friendly programming and services,
d) common objects library and functional components defining the converged processing elements,
e) open configuration management supporting system reconfiguration in base-band parts, RF parts, antenna parts and networking parts, etc.

11. A system as recited in claim 2 wherein said open wireless BIOS defining the basic interface structure for the said various different air-interfaces/wireless standards (either common standards or user-defined), said standards switching, said functional modules as well as switching between internal and/or external said modules, etc.

12. A method as recited in claim 2 providing a smart antenna processing module for said OWA system, said method comprising:
a) using antenna arrays to process radio signals in space, not only time, to improve performance in presence of wireless fading and interference,
b) using beamforming algorithm to increase received signal-over-noise-rate (SNR) for desired directions,
c) using diversity algorithm to combat fading in order to work at less SNR,
d) using interference mitigation method to maximally reuse the channel frequencies,
e) using spatial multiplexing algorithms to increase data speeds, for example, MIMO (multiple-in and multiple-out), etc.

13. A system as recited in claim 2 wherein said software definable module in said wireless terminal device can be stored in or installed from said external memory card (or SIM card), or downloaded from any available networking facilities of said wireless terminal device.

14. A method as recited in claim 3 providing a convergence layer module for said OWA system, said method comprising:
a) open service convergence including transparent integrated services across both wireline and wireless networks, etc,
b) open transport convergence including IP (internet protocol) enterprise convergence and All-IP end-to-end convergence, etc,
c) open transmission convergence including adaptive modulation, adaptive coding and adaptive equalization, etc.

15. A Fourth Generation Mobile Terminal for said wireless terminal device, said terminal comprising:
a) communication/system hardware and peripherals including displayer, digital camera, sensors, smart antennas, security button, radiation detector, health detector and GPS receiver, etc,
b) software detecting available wireless networks in the service region,
c) software configuring the detected wireless networks and installing the modules if needed,
d) software providing the information input methods for said terminal,
e) software providing enhanced security solutions for said terminal,
f) software providing connection methods for said terminal including traditional mobile networking, ad-hoc, broadcasting or user-defined topology,
g) software defining user-preferred service mode based on quality-of-service, bandwidth, traffic model, billing model, etc,
h) software providing future-proven safety solutions for said terminal,
i) software supporting next generation spectrum management methods including spectrum sharing and multiple spectrum ownership, etc,
j) software providing optimal power management solutions to minimize said terminal power consumption including base-band processing, RF, controller as well as applications, etc,
k) software supporting Voice-over-IP standard for said terminal.

16. A method as recited in claim 15 wherein said information input method comprising:
a) inputting message through screen keyboard, for example, e-mails and short messages, etc,
b) converting the voice into information data through Voice Recognition system of said terminal,
c) capturing information input through short-distance wireless transmission technologies, for example, BlueTooth (BT) standard or Ultra Wide Band (UWB) standard, etc from digital camera, laptop, sensor, detector, etc,
d) inputting video from digital camera of said terminal,
e) inputting through other user-defined solutions.

17. A method as recited in claim 15 wherein said enhanced security solutions comprising information security, service security and transmission security, etc that the user can define the security levels by said software. Said terminal also supporting finger-print scanning and detecting, and user-defined identification technology.

18. A method as recited in claim 15 wherein said safety solutions comprising:
a) Health Watch providing radiation detection, monitoring and warning for said terminal; scanning of blood pressure or pulse rate; alcohol scanning, temperature scanning, etc,
b) Emergency Detection providing smoke detection, fire detection, gas detection, chemical detection, etc,
c) Emergency Response transmitting the emergency data (safety and location information, etc) automatically to emergency center, activating the said terminal emergency mode subject to either personal emergency or city-wide emergency where the whole wireless network resource will be reconfigured to support emergency communications as highest priority.

19. An Open Wireless Architecture (OWA) for fourth generation mobile communications said system providing a cost-effective business model and method for vendors, operators and providers of said various different wireless standards, said method comprising:
a) open spectrum management saving lots of investment in spectrum allocation,
b) open architecture saving lots of marketing costs of different standards and services,
c) open architecture saving lots of costs in infrastructure investment,
d) open architecture saving lots of costs on interoperability issues,
e) open resource management optimizing the network resource and system capacity.

20. A method as recited in claim 19 wherein said operators and providers share their revenues based on services sale, value chain, access infrastructure and other to-be-defined criteria of the business.
